(19) United States
(12) Patent Application Publication
(10) Pub. No.: US 2022/0351065 A1
(43) Pub. Date: Nov. 3, 2022

(54) MACHINE LEARNING ASSISTED DISCOVERY OF OPERATING SYSTEM-PROVIDED FEATURES

(71) Applicant: MICROSOFT TECHNOLOGY LICENSING, LLC, Redmond, WA (US)

(72) Inventor: Sarjana Sheth MITRA, Yarrow Point, WA (US)

(21) Appl. No.: 17/242,623

(22) Filed: Apr. 28, 2021

(51) Int. Cl. G06N 20/00; G06F 9/451

(52) U.S. Cl. CPC G06N 20/00; G06F 9/451

(57) ABSTRACT

Technologies for machine learning assisted discovery and instantiation of operating system (OS)-provided features are disclosed. User activity data is collected that defines the activity of a user with respect to a computing device. The user activity data is provided to a trained machine learning model that is configured to predict an OS-provided feature that is relevant to a current activity of the user as indicated by the user activity data. If the trained machine learning model identifies an OS-provided feature that is relevant to the current activity of the user, a user interface (UI) can be presented to the user that includes data identifying the OS-provided feature selected by the trained machine learning model. The UI can also include an element which, when selected, will cause the computing device to execute the OS-provided feature selected by the trained machine learning model based on the user activity data.

### BACKGROUND

The functionality provided by early computer operating systems was generally limited to a core set of functions for launching applications, copying files, and other basic tasks. Modern operating systems, however, commonly provide extensive sets of features for efficiently performing a wide range of tasks. These features can be accessed in a wide variety of ways such as, for example, through operating system (“OS”)-provided menus, context-specific menus, keyboard shortcuts, OS-provided applications like applications for modifying system settings, and others.

Given the large number of OS-provided features and the large number of modalities that can be used to access the features provided by modern operating systems, it can commonly be difficult for users to locate features of interest. As a result, users frequently do not discover these features. As an additional consequence, users might perform specific tasks in a much less efficient manner than they would if they utilized specific OS-provided features for accomplishing the same tasks. Performing tasks inefficiently in this manner can result in the unnecessary utilization of computing resources, such as processor cycles, memory, and network bandwidth.

Some operating systems do provide functionality for notifying users of the availability of various OS-provided features. For example, during boot time an operating system might present a user interface identifying new operating system features or providing tips about using the operating system itself. In many cases, however, users do not pay attention to these messages. Users that do read such messages might quickly forget about the content and, as a result, never use the advertised feature or features. As described above, therefore, users might still perform certain tasks in a much less efficient manner than they would if they utilized a specific OS-provided feature for accomplishing the same tasks, which can result in the unnecessary utilization of computing resources such as those described above.

It is with respect to these and other technical challenges that the disclosure made herein is presented.

### SUMMARY

Technologies are disclosed for machine learning assisted discovery of OS-provided features. Through implementations of the disclosed technologies, an OS-provided feature that is relevant to a user's current activity can be identified and advertised to the user at the time the functionality provided by the feature would be relevant to the user. The user can then request to instantiate the OS-provided feature in order to complete their task more efficiently than they would have been able to if they had not used the OS-provided feature. This can save computing resources such as, but not limited to, processor cycles, memory, and network bandwidth. Other technical benefits not specifically mentioned herein can also be realized through implementations of the disclosed subject matter.

In order to realize the technical benefits mentioned briefly above, and potentially others, user activity data is collected on a computing device with a user's express consent. The user activity data defines the activity of a user with respect to the computing device. For example, and without limitation, the user activity data might include user input data describing keyboard or mouse user input made to the computing device, tasks performed by the user within the OS such as, for example, copying files or taking other action within the UI shell of an OS, launching of applications, and other types of activity performed by a user.

In one embodiment, the user activity data is provided to a trained machine learning model that is configured to identify an OS-provided feature that is relevant to a current activity of the user as defined by the user activity data. For example, and without limitation, the user activity data might indicate that the user is attempting to send an image or another type of file. In response thereto, the trained machine learning model might select an OS-provided feature for efficiently sending files to nearby computing devices.

If the trained machine learning model does identify an OS-provided feature that is relevant to the current activity of the user, a user interface (UI) can be presented to the user that includes data identifying and describing the OS-provided feature selected by the trained machine learning model. For instance, in the example above, a graphical UI might be presented asking the user if they would like to utilize the OS-provided feature for transferring files to nearby computing devices. Other types of visual and audible user interfaces can be provided in various embodiments.

The UI can also include an element which, when selected, will cause the computing device to instantiate (i.e., execute) the OS-provided feature selected by the trained machine learning model. In the example presented above, for instance, the OS-provided feature for sharing files with nearby computing devices might be launched for use by the user. In this way, an OS-provided feature for performing a specific task can be exposed to a user and instantiated at the particular moment that the user needs to utilize the OS-provided feature rather than at boot time or another time at which the feature is not needed.

The UI can also include an element through which the user can indicate that the OS-provided feature selected by the trained machine learning model is not to be instantiated. In this case, the fact that the user deemed the selected OS-provided feature not to be relevant to their current activity can be seen as an indication that the trained machine learning model has made a poor prediction. Accordingly, retraining of the trained machine learning model can be triggered in response to the user request to not instantiate the OS-provided feature.

According to various embodiments, the OS-provided feature might be an OS-provided feature for sharing files with nearby computing devices, an OS-provided feature for providing a system-wide emoji picker, an OS-provided feature for launching an application (e.g. an application for completing a task relating to the current activity of the user), or an OS-provided clipboard history feature. The disclosure presented herein can also be utilized with other types of OS-provided features in other embodiments.

As discussed briefly above, implementations of the technologies disclosed herein can enable more efficient completion of tasks using OS-provided features, thereby saving computing resources as compared to when tasks are completed using less efficient methods. Other technical benefits not specifically identified herein can also be realized through implementations of the disclosed technologies.

It should be appreciated that the above-described subject matter can be implemented as a computer-controlled apparatus, a computer-implemented method, a computing device, or as an article of manufacture such as a computer readable medium. These and various other features will be apparent from a reading of the following Detailed Description and a review of the associated drawings.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a computing architecture diagram that shows a high-level overview of one mechanism disclosed herein for machine learning assisted discovery and instantiation of OS-provided features, according to embodiments disclosed herein;

FIG. 2 is a computing architecture diagram that illustrates aspects of one mechanism disclosed herein for training a machine learning model to identify relevant OS-provided features based on user activity data, according to embodiments disclosed herein;

FIG. 3 is a flow diagram showing a routine that illustrates aspects of the mechanism shown in FIG. 2 for training a machine learning model to identify relevant OS-provided features based on user activity data according to one embodiment disclosed herein;

FIG. 4 is a computing architecture diagram that illustrates aspects of one mechanism disclosed herein for machine learning assisted discovery and instantiation of OS-provided features, according to one embodiment disclosed herein;

FIG. 5 is a flow diagram showing a routine that illustrates aspects of the mechanism shown in FIG. 4 for machine learning assisted discovery and instantiation of OS-provided features, according to one embodiment disclosed herein;

FIG. 6 is a user interface diagram showing aspects of one mechanism disclosed herein for machine learning assisted discovery and instantiation of an OS-provided feature for transmitting images to nearby computing devices, according to one embodiment disclosed herein;

FIG. 7 is a user interface diagram showing aspects of one mechanism disclosed herein for machine learning assisted discovery and instantiation of an OS-provided feature for providing a system-wide emoji picker, according to one embodiment disclosed herein;

FIG. 8 is a user interface diagram showing aspects of one mechanism disclosed herein for machine learning assisted discovery and instantiation of an OS-provided feature for providing a clipboard history, according to one embodiment disclosed herein;

FIG. 9 is a computer architecture diagram showing an illustrative computer hardware and software architecture for a computing device that can implement aspects of the technologies presented herein; and

FIG. 10 is a network diagram illustrating a distributed computing environment in which aspects of the disclosed technologies can be implemented.

### DETAILED DESCRIPTION

The following detailed description is directed to technologies for machine learning assisted discovery and instantiation of OS-provided features. As discussed briefly above, implementations of the technologies disclosed herein can enable more efficient completion of tasks on a computing device using OS-provided features, thereby saving computing resources as compared to when tasks are completed using less efficient methods. Other technical benefits not specifically mentioned herein can also be realized through implementations of the disclosed subject matter.

While the subject matter described herein is presented in the general context of machine learning assisted discovery of OS-provided features, those skilled in the art will recognize that other implementations can be performed in combination with other types of computing systems and modules. Those skilled in the art will also appreciate that the subject matter described herein can be practiced with other computer system configurations, including hand-held devices, multiprocessor systems, microprocessor-based or programmable consumer electronics, computing or processing systems embedded in devices (such as wearable computing devices, automobiles, home automation etc.), minicomputers, mainframe computers, and the like.

In the following detailed description, references are made to the accompanying drawings that form a part hereof, and which are shown by way of illustration specific configurations or examples. Referring now to the drawings, in which like numerals represent like elements throughout the several FIGS., aspects of various technologies for machine learning assisted discovery and instantiation of OS-provided features will be described.

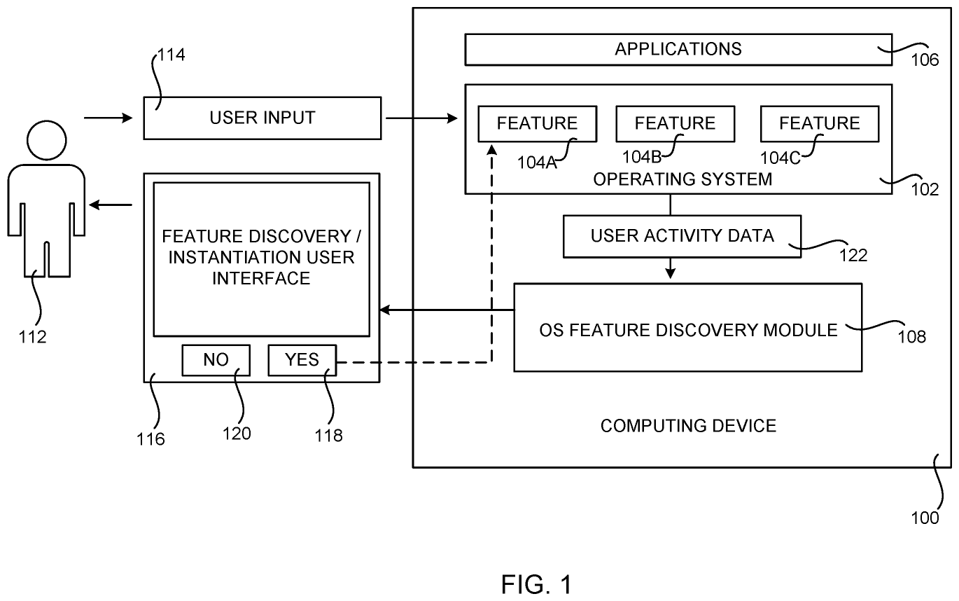

FIG. 1 is a computing architecture diagram that shows a high-level overview of one mechanism disclosed herein for machine learning assisted discovery and instantiation of OS-provided features, according to embodiments disclosed herein. As discussed briefly above, the functionality provided by early computer operating systems was generally limited to a core set of functions for launching applications, copying files, and other basic tasks.

Modern operating systems, such as the OS 102 executing on the computing device 100 shown in FIG. 1, however, commonly provide extensive sets of additional features 104A-104C (which might be collectively referred to as “OS-provided features 104” or just “OS features 104”) for efficiently performing a wide range of tasks. The OS features 104 can be accessed in a wide variety of ways such as, for example, through OS-provided menus, context-specific menus, keyboard shortcuts, OS-provided applications like applications for modifying system settings, and others. Modern operating systems 102 also provide basic features for launching applications 106, copying files, and other basic productivity tasks.

Given the large number of OS-provided features 104 and the large number of modalities that can be used to access the OS features 104 provided by modern operating systems 102, it can commonly be difficult for users 112 to locate OS-provided features 104 of interest. As a result, users 112 frequently do not discover or utilize these features. As an additional consequence, users 112 might perform specific tasks in a much less efficient manner than they would if they utilized specific OS-provided features 104 for accomplishing the same tasks. Performing tasks inefficiently in this manner can result in the inefficient utilization of computing resources, such as processor cycles, memory, and network bandwidth.

As mentioned above, some operating systems do provide functionality for advertising the availability of various OS-provided features 104 to users 112. For example, during boot time an OS 102 might present a user interface identifying new OS-provided features 104 or providing tips about using the OS 102 itself. In many cases, however, users 112 do not pay attention to these messages. Users 112 that do read such messages might quickly forget about the content and, as a result, never use the advertised feature or features 104. As described above, therefore, users 112 might still perform specific tasks in a much less efficient manner than they would if they utilized a specific OS-provided feature 104 for accomplishing the same tasks, which can result in the unnecessary utilization of computing resources. It is respect to these and other considerations that the disclosure made herein is presented.

In order to address the technical challenges set forth above, and potentially others, technologies are disclosed herein for machine learning assisted discovery of OS-provided features 104. As discussed briefly above, through implementations of the disclosed technologies, OS-provided features 104 that are relevant to a user's current activity can be discovered and identified to users 112 at the time the functionality provided by the feature 104 would be relevant to the user.

Users 112 can then request to instantiate the OS-provided feature 104 in order to complete their task more efficiently than they would have been able to if they had not used the OS-provided feature 104. This can save computing resources such as, but not limited to, processor cycles, memory, and network bandwidth. Other technical benefits not specifically mentioned herein can also be realized through implementations of the disclosed subject matter.

In order to realize the technical benefits mentioned briefly above, and potentially others, a user 112 makes user input 114 to a computing device 100 and user activity data 122 is collected that describes the user's activity on the computing device 100. Express consent for collection and use of the user's activity data 122 is obtained in advance of such collection and use.

The user activity data 122 defines the activity of a user 112 with respect to the computing device 100. For example, and without limitation, the user activity data might 122 include data describing keyboard or mouse user input 114 made to the computing device 100, tasks performed by the user 112 within the OS 102 such as, for example, copying files, or taking other action within the UI shell of the OS 102, launching of applications 106, and other types of activity performed by the user 112.

In one embodiment, the user activity data 122 is provided to an OS feature discovery module 108. The OS feature discovery module 108 includes a trained machine learning model (not shown in FIG. 1) that is configured to select an OS-provided feature 104 that is relevant to a current activity of the user 112 as defined by the user activity data 122. For example, and without limitation, the user activity data 122 might indicate that the user 112 is attempting to send an image or another type of file. In response thereto, the trained machine learning model might select an OS-provided feature 104A for efficiently sending files to nearby computing devices.

If the trained machine learning model does identify an OS-provided feature 104A that is relevant to the current activity of the user 112, a UI 116 (which might be referred to herein as the “feature discovery/instantiation UI 116”) can be presented to the user 112 that includes data identifying the OS-provided feature 104A selected by the trained machine learning model. For instance, in the example above, a UI 116 might be presented asking the user 112 if they would like to utilize the OS-provided feature 104A for transferring files to nearby computing devices. Other types of visual and audible user interfaces identifying an identified OS-provided feature 104A can be provided in various embodiments.

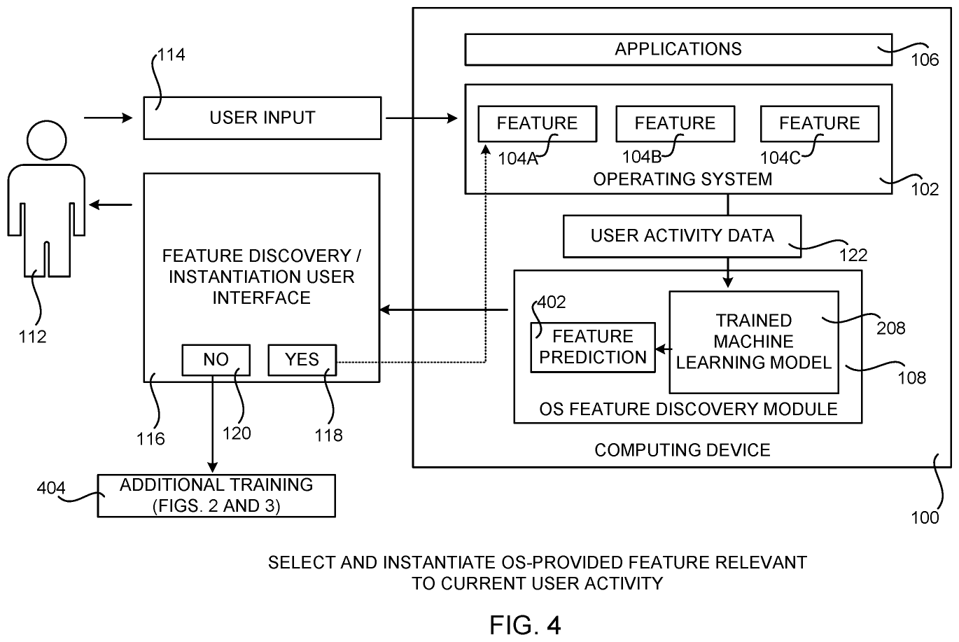

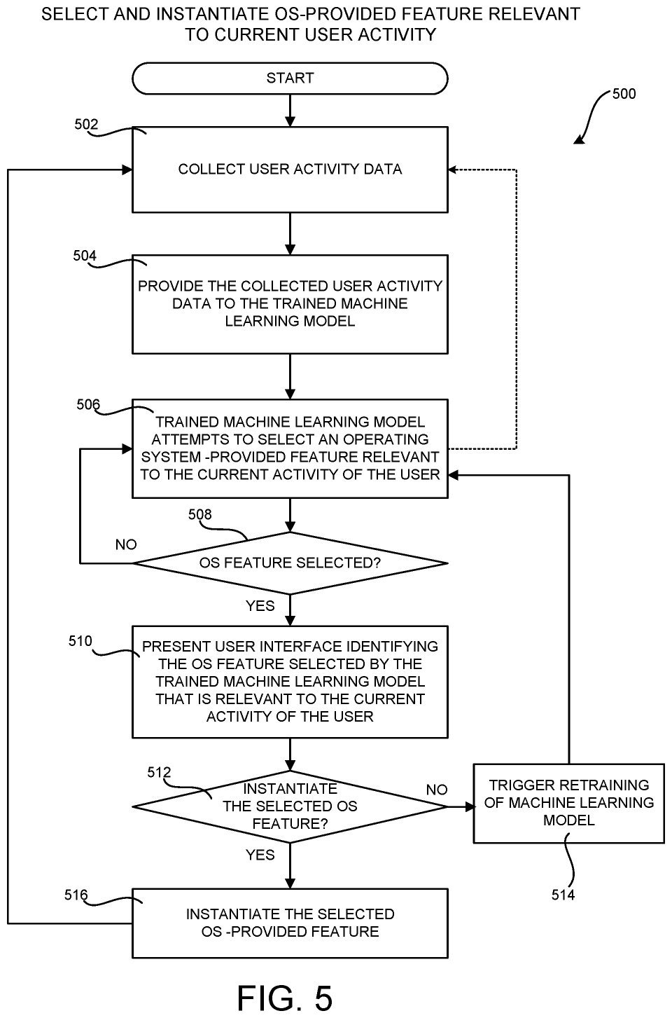

As shown in FIG. 1, the UI 116 can also include a UI element 118 which, when selected, will cause the computing device 110 to instantiate (i.e., execute) the OS-provided feature 104A selected by the trained machine learning model. In the example presented above, for instance, the OS-provided feature 104A for sharing files with nearby computing devices might be launched for use by the user 112. In this way, an OS-provided feature 104 for performing a specific task can be exposed to a user 112 and instantiated at the particular moment that the user 112 needs to utilize the OS-provided feature 104 rather than at boot time or another time at which the feature 104 is not needed. Additional details regarding the utilization of a trained machine learning model to identify and instantiate OS-provided features 104 will be provided below with regard to FIGS. 4 and 5.

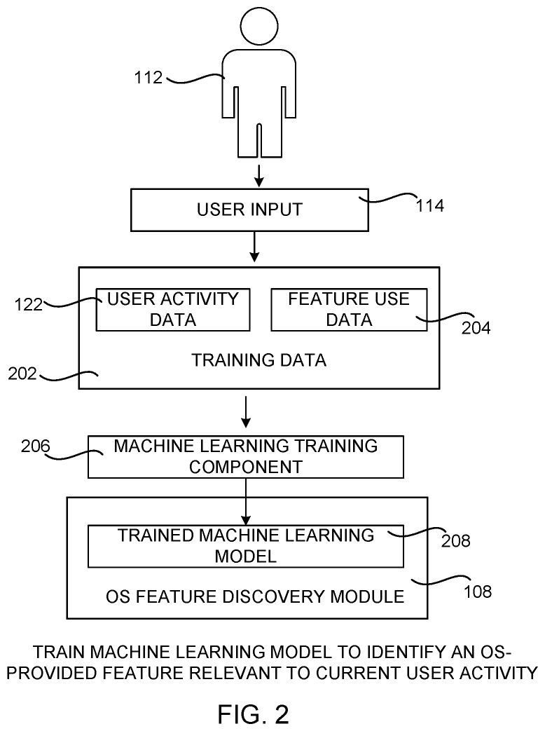

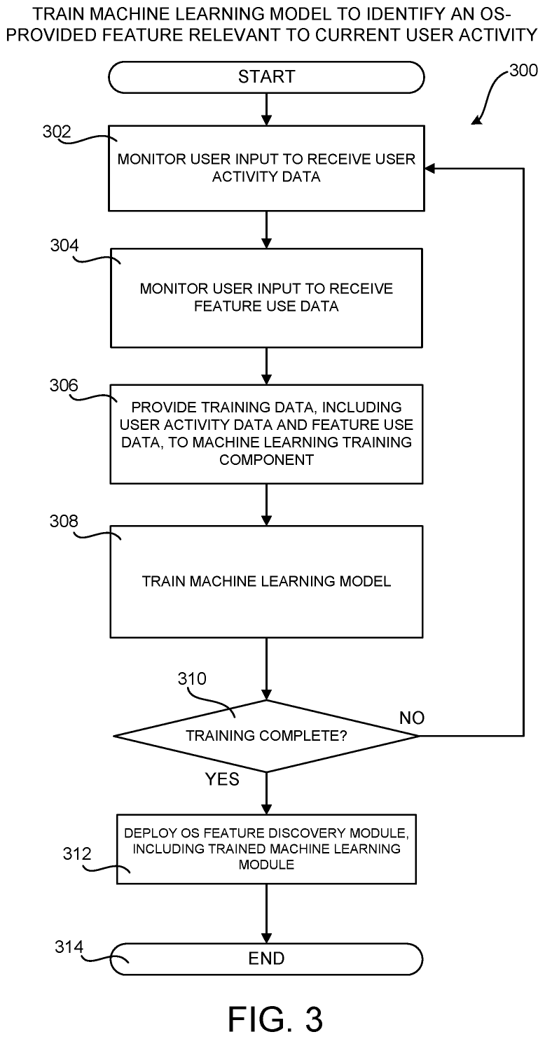

The UI 116 can also include an element 120 through which the user 112 can indicate that the OS-provided feature 104A selected by the trained machine learning model is not to be instantiated. In this case, the fact that the user 112 deemed the selected OS-provided feature 104A not to be relevant to their current activity can be seen as an indication that the trained machine learning model has made a poor prediction. Accordingly, retraining of the trained machine learning model can be triggered in response to the user request to not instantiate the OS-provided feature. Additional details regarding the training and retraining of the machine learning model used by the OS feature discovery module 108 will be provided below with regard to FIGS. 2 and 3.

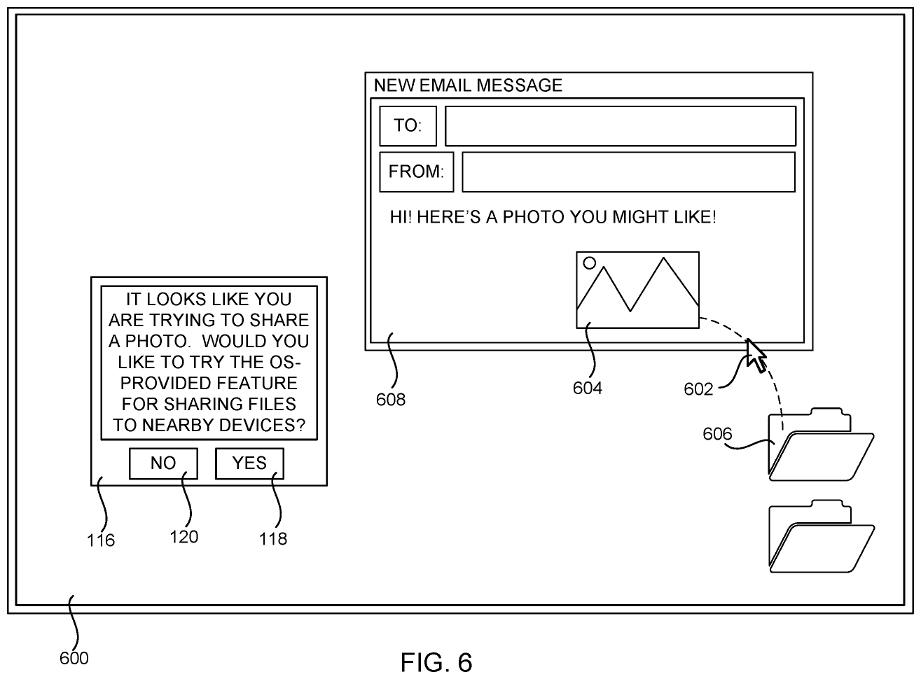

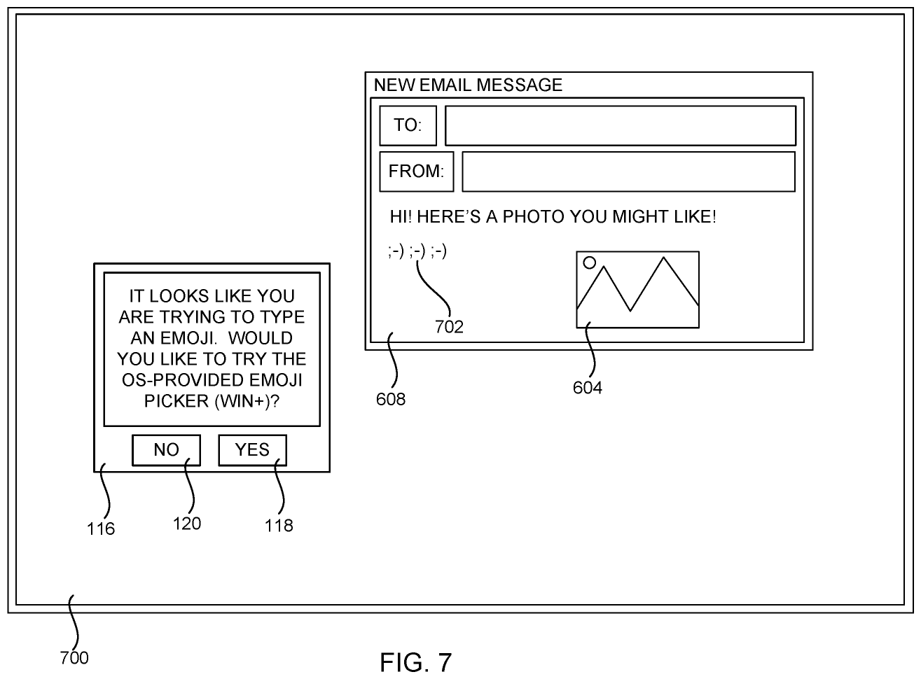

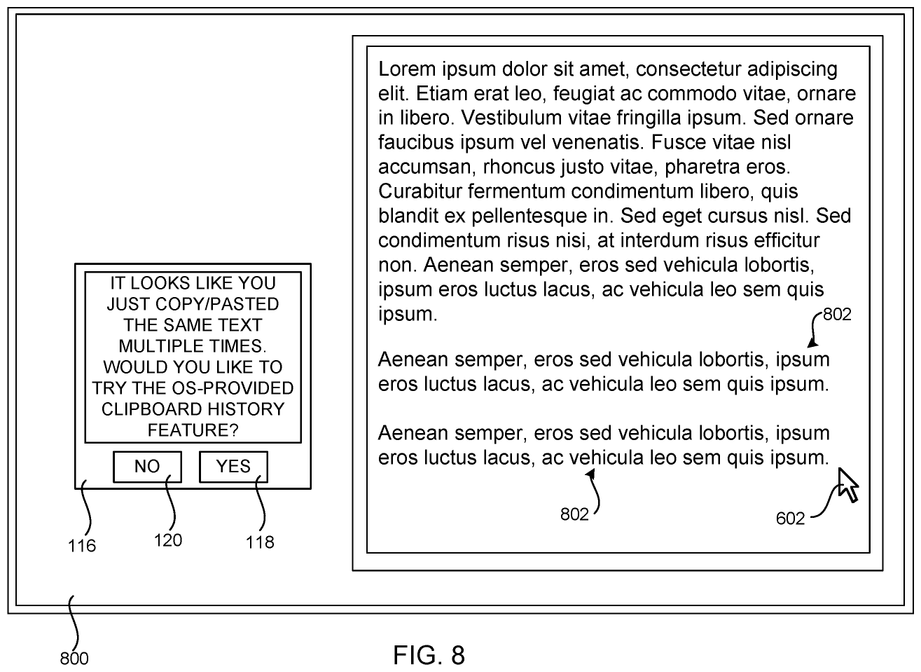

According to various embodiments, the OS-provided feature 104 might be an OS-provided feature 104 for sharing files with nearby computing devices. Additional details regarding the selection, advertisement, and instantiation of this feature are provided below with respect to FIG. 6. The OS-provided feature 104 might alternately be an OS-provided feature 104 for providing a system-wide emoji picker. Additional details regarding the selection, advertisement, and instantiation of this feature are provided below with respect to FIG. 7. The OS-provided feature 104 might alternately be an OS-provided clipboard history feature. Additional details regarding the selection, advertisement, and instantiation of this feature are provided below with respect to FIG. 8. The OS-provided feature 104 might alternately be an OS-provided feature for launching an application that provides functionality relevant to a user's current activity. The disclosure presented herein can also be utilized with other types of OS-provided features 104 in other embodiments.

FIG. 2 is a computing architecture diagram that illustrates aspects of one mechanism disclosed herein for training a machine learning model 208 to identify relevant OS-provided features 104 based on user activity data 122, according to embodiments disclosed herein. In order to train the machine learning model 208, a training phase is performed during which user input 114 to a computing device 100 is monitored and user activity data 122 is collected that describes the user's activity on the computing device 100. Express consent for collection and use of the user's activity data 122 is obtained in advance of such collection and use.

As discussed above, the user activity data 122 defines the activity of a user 112 with respect to the computing device 100. For example, and without limitation, the user activity data 122 might include data describing keyboard or mouse user input 114 made to the computing device 100, tasks performed by the user 112 within the OS 102 such as, for example, copying files, or taking other action within the UI shell of the OS 102, launching of applications 106, and other types of activity performed by the user 112. As will be described in greater detail below, the user activity data 122 is used as training data 202 for the machine learning model 208.

During the user's interaction with the computing device 100, the user 112 can also utilize OS-provided features 104. Feature use data 204 that describes the user's utilization of OS-provided features 104 is also stored and utilized as training data 202 for the machine learning model 208.

As shown in FIG. 2, the training data 202, including the user activity data 122 and the feature use data 204, is provided to a machine learning training component 206 in one embodiment. The machine learning training component 206 is configured to train the machine learning model 208 to identify OS-provided features 104 that are relevant to a user's current activity as indicated by the user activity data 122. In this way, at run time the trained machine learning model 208 can receive activity data 122 describing a user's current activity (with the user's express consent) and identify and surface an OS-provided feature 104 that is relevant to the current activity of the user 112 as defined by the user activity data 122.

Once the training data 202 has been obtained, the machine learning training component 206 can be utilized to generate the trained machine learning model 208. Training can include various types of machine learning including, but not limited to, supervised or unsupervised machine learning, reinforcement learning, self-learning, feature learning, sparse dictionary learning, anomaly detection, or association rules. Accordingly, the trained machine learning model 208 can be implemented as one or more of artificial neural networks, decision trees, support vector machines, regression analysis, Bayesian networks, or genetic algorithms. Other machine learning techniques known to those skilled in the art can also be utilized in other embodiments.

Training in the manner shown in FIG. 2 can be performed repeatedly and with many different users in order to ensure that the trained machine learning model 208 can accurately predict relevant OS-features 104 for a user's current activity. Once it has been trained, the trained machine learning model 208 can be deployed to a user's computing device 100 to identify an OS-feature 104, or features 104, relevant to a user's current activity and to surface information about the feature 104 or features 104. Additional details regarding this process will be provided below with regard to FIGS. 4 and 5.

As mentioned briefly above, interaction by a user 112 with the feature discovery/instantiation user interface 116 can be utilized to continually update the trained machine learning model 208 to improve its ability to accurately identify relevant OS-features 104 relating to user-specified activities based upon user the user activity data 122. For instance, and as described briefly above, the UI 116 can include an element 120 through which the user 112 can indicate that an OS-provided feature 104 selected by the trained machine learning model 208 is not to be instantiated (i.e., not executed). In this case, the fact that the user 112 deemed the identified OS-provided feature 104 not to be relevant to their current activity can be seen as an indication that the trained machine learning model 208 has made a poor prediction. Accordingly, retraining of the trained machine learning model 208 can be triggered in response to the user request to not instantiate the OS-provided feature.

FIG. 3 is a flow diagram showing a routine 300 that illustrates aspects of the mechanism shown in FIG. 2 for training a machine learning model 208 to identify relevant OS-provided features 104 based on user activity data 122 according to one embodiment disclosed herein. It should be appreciated that the logical operations described herein with regard to FIG. 3, and the other FIGS., can be implemented (1) as a sequence of computer implemented acts or program modules running on a computing device and/or (2) as interconnected machine logic circuits or circuit modules within a computing device.

The particular implementation of the technologies disclosed herein is a matter of choice dependent on the performance and other requirements of the computing device. Accordingly, the logical operations described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein.

The routine 300 begins at operation 302, where user input 114 to a computing device 100 is monitored during the user's normal use of the computing device, and user activity data 122 is collected that describes the user's activity on the computing device 100. As discussed above, the user activity data 122 defines the activity of a user 112 with respect to the computing device 100. Express consent for collection and use of the user's activity data 122 is obtained in advance of such collection and use.

From operation 302, the routine 300 proceeds to operation 304, where user input 114 to the computing device 100 is monitored during the user's normal use of the computing device and feature use data 204 is collected that describes the user's interaction with OS-provided features 104.

From operation 304, the routine 300 proceeds to operation 306, where the training data 202, including the user activity data 122 and the feature use data 204, is provided to the machine learning training component 206. The routine 300 then proceeds from operation 306 to operation 308, where the machine learning training component 206 trains the machine learning model 208.

As discussed above, training of the machine learning model 208 can include various types of machine learning including, but not limited to, supervised or unsupervised machine learning, reinforcement learning, self-learning, feature learning, sparse dictionary learning, anomaly detection, or association rules. Accordingly, the trained machine learning model 208 can be implemented as one or more of artificial neural networks, decision trees, support vector machines, regression analysis, Bayesian networks, or genetic algorithms. Other machine learning techniques known to those skilled in the art can also be utilized in other embodiments.

From operation 308, the routine 300 proceeds to operation 310, where a determination is made as to whether training of the machine learning model 208 has completed. If training has not yet completed, the routine 300 proceeds back from operation 310 to operation 302, where additional training data 202 can be collected and additional training can occur in the manner described above.

If, at operation 310, it is determined that training has completed, the routine 300 proceeds from operation 310 to operation 312. At operation 312, the OS feature discovery module 108, including the trained machine learning module 208, can be deployed for run time identification and advertisement of OS-provided features 104 that are relevant to a user's current activity. Additional details regarding this process are provided below with regard to FIGS. 4 and 5.

FIG. 4 is a computing architecture diagram that illustrates additional aspects of one mechanism disclosed herein for machine learning assisted discovery and instantiation of OS-provided features 104, according to one embodiment disclosed herein. As discussed above, a user 112 makes user input 114 to a computing device 100 and user activity data 122 is collected that describes the user's activity on the computing device 100. Express consent for collection and use of the user's activity data 122 is obtained in advance of such collection and use.

As also discussed above, the user activity data 122 defines the activity of a user 112 with respect to the computing device 100. For example, and without limitation, the user activity data might 122 include data describing keyboard or mouse user input 114 made to the computing device 100, tasks performed by the user 112 within the OS 102 such as, for example, copying files, or taking other action within the UI shell of the OS 102, launching of applications 106, and other types of activity performed by the user 112.

The user activity data 122 is provided to an OS feature discovery module 108. As discussed above, the OS feature discovery module 108 includes a trained machine learning model 208 that is configured to make a feature prediction 402 that identifies an OS-provided feature 104 that is relevant to a current activity of the user 112 as defined by the user activity data 122. For example, and without limitation, the user activity data 122 might indicate that the user 112 is attempting to send an image or another type of file. In response thereto, the trained machine learning model might select an OS-provided feature 104A for efficiently sending files to nearby computing devices.

If the trained machine learning model 208 does identify an OS-provided feature 104A that is relevant to the current activity of the user 112, a UI 116 can be presented to the user 112 that includes data identifying the OS-provided feature 104A selected by the trained machine learning model 208. For instance, in the example above, a UI 116 might be presented asking the user 112 if they would like to utilize the OS-provided feature 104A for transferring files to nearby computing devices. Other types of visual and audible user interfaces identifying an identified OS-provided feature 104A can be provided in various embodiments.

As shown in FIG. 4 and described briefly above, the UI 116 can also include a UI element 118 which, when selected, will cause the computing device 110 to instantiate the OS-provided feature 104A predicted by the trained machine learning model 208. In the example presented above, for instance, the OS-provided feature 104A for sharing files with nearby computing devices might be launched for use by the user 112. In this way, an OS-provided feature 104 for performing a specific task can be exposed to a user 112 and instantiated at the time that the user 112 needs to utilize the OS-provided feature 104 rather than at boot time or another time at which the feature 104 is not needed.

As also mentioned briefly above, the UI 116 can also include an element 120 through which the user 112 can indicate that the OS-provided feature 104A selected by the trained machine learning model 208 is not to be instantiated. In this case, the fact that the user 112 deemed the selected OS-provided feature 104A not to be relevant to their current activity can be seen as an indication that the trained machine learning model 208 has made a poor prediction. Accordingly, retraining 404 of the trained machine learning model 208 in the manner described above with regard to FIGS. 2 and 3 can be triggered in response to the user request to not instantiate the OS-provided feature. In this manner, the ability of the machine learning model 208 to predict and advertise a relevant OS-provided feature 104 can be improved over time based upon user feedback. Additional details regarding this process are provided below with regard to FIG. 5.

FIG. 5 is a flow diagram showing a routine 500 that illustrates aspects of the mechanism shown in FIG. 4 for machine learning assisted discovery and instantiation of OS-provided features 104, according to one embodiment disclosed herein. The routine 500 begins at operation 502, where user activity data 122 is collected in the manner described above during a user's normal use of a computing device 100. The routine 500 then proceeds from operation 502 to operation 504, where the collected user activity data 122 is provided to the trained machine learning model 208.

From operation 504, the routine 500 proceeds to operation 506, where the trained machine learning model 208 attempts to generate a prediction 402 of an OS-provided feature 104 that is relevant to the current activity of the user 112 based upon the collected user activity data 122. The dashed line in FIG. 5 indicates that collection and analysis of the user activity data 122 is performed continually as a user interacts with the computing device 100 so that OS-provided features 104 that are most relevant to a user's current activity can be identified and surfaced to the user 112.

From operation 506, the routine 500 proceeds to operation 508, where a determination is made as to whether the trained machine learning model 208 was able to predict an OS-provided feature 104 relevant to the user's current activity. If not, the routine 500 proceeds back to operation 506, where the trained machine learning model 208 can continue to process the user activity data 122 and attempt to identify relevant OS-provided features 104.

If the trained machine learning model 208 is able to identify an OS-provided feature 104 that is relevant to the user's current activity, the routine 500 proceeds from operation 508 to operation 510, where a UI 116 is presented to the user 112 that identifies the OS-provided feature selected by the trained machine learning model 208 that is relevant to the current activity of the user 112.

As discussed above, the UI 116 includes an element 118 which, when selected, will instantiate the selected OS-provided feature 104 and an element 120 which, when selected, will cause the OS-provided feature not to be instantiated. If the user 112 selects the element 118, the routine 500 proceeds to operation 516, where the selected OS-provided feature 104 is instantiated (i.e., executed). The routine 500 then returns back to operation 502, where the process described above may be repeated.

If the user 112 selects the element 120, the routine 500 proceeds from operation 512 to operation 514, where retraining 404 of the machine learning model 208 might be performed in the manner described above. The routine 500 then proceeds from operation 514 to operation 506, where the process described above may be repeated.

FIG. 6 is a user interface diagram showing aspects of one mechanism disclosed herein for machine learning assisted discovery and instantiation of an OS-provided feature 104 for transmitting images or other types of files to nearby computing devices, according to one embodiment disclosed herein. In this example, the OS 102 includes a feature 104 for sharing documents, photos, links to web sites, and other information to nearby computing devices using WI-FI or BLUETOOTH.

If a user 112 of the computing device 100 is not aware of the existence of the nearby sharing feature 104, the user might attempt to share photos or other types of files using email or another communication mechanism. This process, however, can be complex and, as a result, utilize computing resources unnecessarily. The technologies disclosed herein can help a use discover and utilize the nearby sharing feature at the time they need the functionality that it provides.

In the example shown in FIG. 6, for instance, a user has created an email message 608 and dragged a photo 604 from a folder 606 on the OS desktop 600 to the email message 608 using a mouse cursor 602. These events would be reflected in the user activity data 122 provided to the trained machine learning model 208. Based on this user activity data 122, the trained machine learning model 208 may make a prediction 402 that the user is trying to send a photo to a nearby computing device and identify the OS-provided nearby sharing feature 104 as a feature that is relevant to the activity that the user 112 is currently trying to perform.

In response to identifying the nearby sharing feature 104 as a feature that is relevant to the activity that the user 112 is currently trying to perform, the OS feature discovery module 108 (or another module) might present the UI 116. In this example, the UI 116 includes text identifying and describing the identified feature 104 and asking the user 112 if they would like to instantiate the feature 104.

If the user 112 selects the element 118, the OS-provided nearby sharing feature 104 is executed (not shown in FIG. 6). If the user 112 selects the element 120, the OS-provided nearby sharing feature 104 is not executed and retraining 404 might occur in the manner described above. In either case, the UI 116 is dismissed. As discussed above, the UI 116 is merely illustrative and that other types of user interfaces can be provided in other embodiments.

FIG. 7 is a user interface diagram showing aspects of one mechanism disclosed herein for machine learning assisted discovery and instantiation of an OS-provided feature 104 for providing a system-wide emoji picker, according to one embodiment disclosed herein. In this example, the OS 102 provides a feature 104 for providing a system-wide emoji picker. As known in the art, an emoji is a small digital image or icon used to express an idea or emotion, such as happiness or sadness. In order to instantiate the system-wide emoji picker feature 104, a user must press a predefined sequence of hot keys, which many users might not know.

If a user 112 of the computing device 100 is not aware of the existence of the system-wide emoji picker feature 104 or the hot key sequence needed to instantiate the feature, the user might attempt to type out an emoji manually. This process, however, can take time and will typically not provide the end result that the user desires. The technologies disclosed herein can help a use discover and utilize the system-wide emoji picker feature 104 at the time they need the functionality that it provides.

In the example shown in FIG. 6, for instance, a user has created an email message 608 and manually typed out the characters for several “smiley face” emoji (i.e., :-)). These events would be reflected in the user activity data 122 provided to the trained machine learning model 208. Based on this user activity data 122, the trained machine learning model 208 may make a prediction 402 that the user is trying to type emoji and identify the OS-provided system-wide emoji picker feature 104 as a feature that is relevant to the activity that the user 112 is currently trying to perform.

In response to identifying the system-wide emoji picker feature 104 as a feature that is relevant to the activity that the user 112 is currently trying to perform, the OS feature discovery module 108 (or another module) might present the UI 116. In this example, the UI 116 includes text identifying and describing the identified feature 104 and asking the user 112 if they would like to instantiate the feature 104. If the user 112 selects the element 118, the OS-provided system-wide emoji picker feature 104 is executed (not shown in FIG. 7). If the user 112 selects the element 120, the OS-provided nearby sharing feature 104 is not executed and retraining 404 might occur in the manner described above. In either case, the UI 116 is dismissed.

FIG. 8 is a user interface diagram showing aspects of one mechanism disclosed herein for machine learning assisted discovery and instantiation of an OS-provided feature 104 for providing a clipboard history, according to one embodiment disclosed herein. In this example, the OS 102 includes a feature 104 for accessing and utilizing a history of items copied to a system clipboard. When instantiated, the clipboard history feature 104 shows a list of items recently copied to the clipboard and allows the user to select the items to paste them.

If a user 112 of the computing device 100 is not aware of the existence of the clipboard history feature 104, the user might attempt to re-copy the text to the clipboard. This process, however, can be complex and, as a result, utilize computing resources unnecessarily. The technologies disclosed herein can help a use discover and utilize the clipboard history feature 104 at the time they need the functionality that it provides.

In the example shown in FIG. 6, for instance, a user has created a document and typed text into the document. The user 112 has also pasted the same text 802 into the document twice. These events would be reflected in the user activity data 122 provided to the trained machine learning model 208. Based on this user activity data 122, the trained machine learning model 208 may make a prediction 402 that the OS-provided clipboard history feature 104 as a feature that is relevant to the activity that the user 112 is currently trying to perform.

In response to identifying the clipboard history feature 104 as a feature that is relevant to the activity that the user 112 is currently trying to perform, the OS feature discovery module 108 (or another module) might present the UI 116. In this example, the UI 116 includes text identifying and describing the identified feature 104 and asking the user 112 if they would like to instantiate the feature 104.

If the user 112 selects the element 118, the OS-provided clipboard history feature 104 is executed (not shown in FIG. 8). If the user 112 selects the element 120, the OS-provided nearby sharing feature 104 is not executed and retraining 404 might occur in the manner described above. In either case, the UI 116 is dismissed.

It is to be appreciated that the OS-provided features 104 shown in FIGS. 6-8 and described above are merely illustrative and that the embodiments disclosed herein can be utilized to enable discover any use of virtually any OS-provided feature 104. As another example, if a user 112 copies details about an event in their web browser, the mechanism described above might advertise an OS-provided feature 104 for copying the details directly to their default calendar application on the computing device 100 or help them discover and launch the calendar application. In this manner, an OS-provided feature for launching an application (i.e., the calendar application in this example) that provides functionality relevant to a user's current activity (i.e., creating a new calendar event in this example) can be utilized to assist a user in discovering and utilizing application-provided functionality that they might not have otherwise discovered. Other OS-provided features 104 can be identified and surfaced in a similar manner.

In some configurations, the OS 102 or applications 106 can provide hints to the trained machine learning model 208 regarding the type of features they provide and the user activities relevant to those features. Through this registration mechanism, the trained machine learning model 208 might become more accurate at identifying features 104 relevant to a user's current activity.

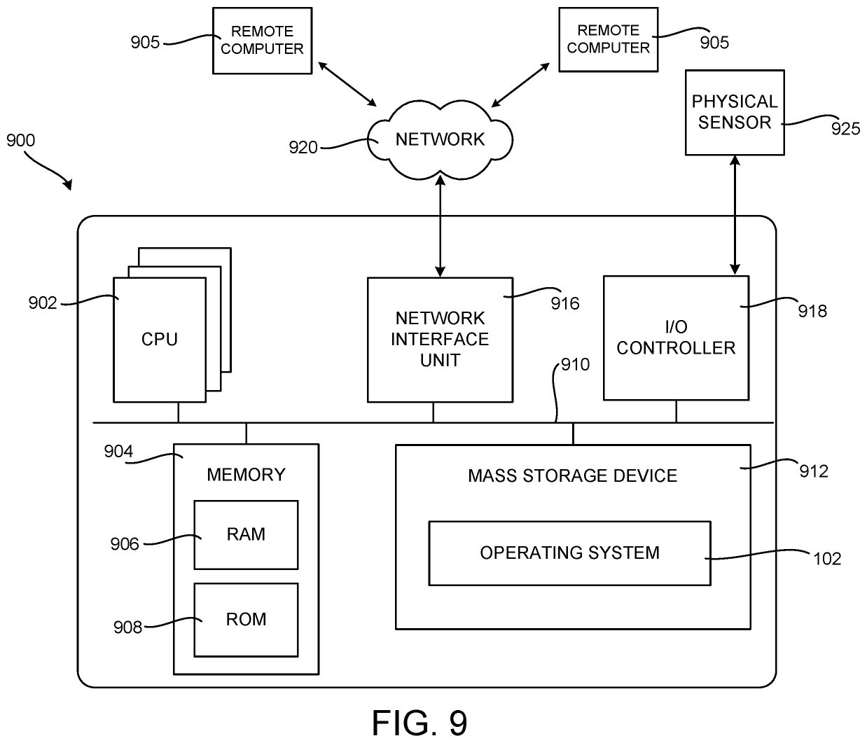

FIG. 9 is a computer architecture diagram showing an illustrative computer hardware and software architecture for a computing device that can implement the various technologies presented herein. In particular, the architecture illustrated in FIG. 9 can be utilized to implement a server computer, mobile phone, an e-reader, a smartphone, a desktop computer, an AR/VR device, a tablet computer, a laptop computer, or another type of computing device. For example, and without limitation, the computer architecture shown in FIG. 9 might be utilized to implement the computing device 100 shown in the FIGS. and described above.

The computer 900 illustrated in FIG. 9 includes a central processing unit 902 (“CPU”), a system memory 904, including a random-access memory 906 (“RAM”) and a read-only memory (“ROM”) 908, and a system bus 910 that couples the memory 904 to the CPU 902. A basic input/output system (“BIOS” or “firmware”) containing the basic routines that help to transfer information between elements within the computer 900, such as during startup, can be stored in the ROM 908. The computer 900 further includes a mass storage device 912 for storing an operating system 102, application programs 106, and other types of programs. The mass storage device 912 can also be configured to store other types of programs and data.

The mass storage device 912 is connected to the CPU 902 through a mass storage controller (not shown) connected to the bus 910. The mass storage device 912 and its associated computer readable media provide non-volatile storage for the computer 900. Although the description of computer readable media contained herein refers to a mass storage device, such as a hard disk, CD-ROM drive, DVD-ROM drive, or USB storage key, it should be appreciated by those skilled in the art that computer readable media can be any available computer storage media or communication media that can be accessed by the computer 900.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, radio frequency, infrared and other wireless media. Combinations of the any of the above should also be included within the scope of computer readable media.

By way of example, and not limitation, computer storage media can include volatile and non-volatile, removable and non-removable media implemented in any method or technology for storage of information such as computer readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium that can be used to store the desired information and which can be accessed by the computer 900. For purposes of the claims, the phrase “computer storage medium,” and variations thereof, does not include waves or signals per se or communication media.

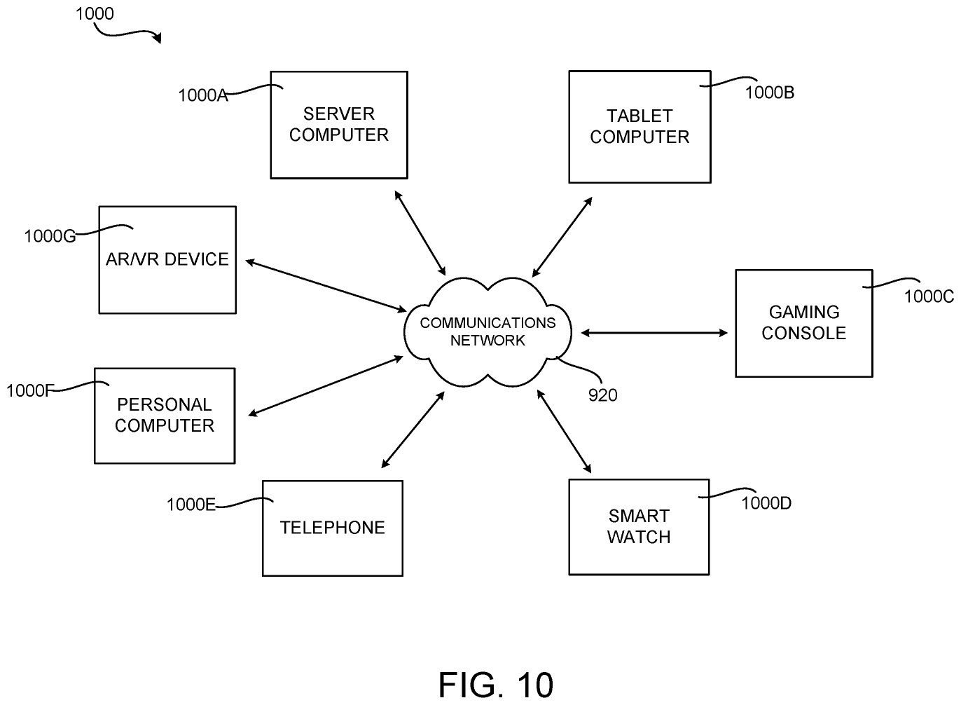

According to various configurations, the computer 900 can operate in a networked environment using logical connections to remote computers through a network such as the network 920. The computer 900 can connect to the network 920 through a network interface unit 916 connected to the bus 910. It should be appreciated that the network interface unit 916 can also be utilized to connect to other types of networks and remote computer systems such as those shown in FIG. 10 and described below. The computer 900 can also include an input/output controller 918 for receiving and processing input from a number of other devices, including a keyboard, mouse, touch input, an electronic stylus (not shown in FIG. 9), or a physical sensor such as a video camera. Similarly, the input/output controller 918 can provide output to a display screen or other type of output device (also not shown in FIG. 9).

It should be appreciated that the software components described herein, when loaded into the CPU 902 and executed, can transform the CPU 902 and the overall computer 900 from a general-purpose computing device into a special-purpose computing device customized to facilitate the functionality presented herein. The CPU 902 can be constructed from any number of transistors or other discrete circuit elements, which can individually or collectively assume any number of states. More specifically, the CPU 902 can operate as a finite-state machine, in response to executable instructions contained within the software modules disclosed herein. These computer-executable instructions can transform the CPU 902 by specifying how the CPU 902 transitions between states, thereby transforming the transistors or other discrete hardware elements constituting the CPU 902.

Encoding the software modules presented herein can also transform the physical structure of the computer readable media presented herein. The specific transformation of physical structure depends on various factors, in different implementations of this description. Examples of such factors include, but are not limited to, the technology used to implement the computer readable media, whether the computer readable media is characterized as primary or secondary storage, and the like. For example, if the computer readable media is implemented as semiconductor-based memory, the software disclosed herein can be encoded on the computer readable media by transforming the physical state of the semiconductor memory. For instance, the software can transform the state of transistors, capacitors, or other discrete circuit elements constituting the semiconductor memory. The software can also transform the physical state of such components in order to store data thereupon.

As another example, the computer readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations can also include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer 900 in order to store and execute the software components presented herein. It also should be appreciated that the architecture shown in FIG. 9 for the computer 900, or a similar architecture, can be utilized to implement other types of computing devices, including hand-held computers, video game devices, embedded computer systems, mobile devices such as smartphones, tablets, and AR/VR devices, and other types of computing devices known to those skilled in the art. It is also contemplated that the computer 900 might not include all of the components shown in FIG. 9, can include other components that are not explicitly shown in FIG. 9, or can utilize an architecture completely different than that shown in FIG. 9.

FIG. 10 is a network diagram illustrating a distributed network computing environment 1000 in which aspects of the disclosed technologies can be implemented, according to various embodiments presented herein. As shown in FIG. 10, one or more server computers 1000A can be interconnected via a communications network 920 (which may be either of, or a combination of, a fixed-wire or wireless LAN, WAN, intranet, extranet, peer-to-peer network, virtual private network, the Internet, Bluetooth communications network, proprietary low voltage communications network, or other communications network) with a number of client computing devices such as, but not limited to, a tablet computer 1000B, a gaming console 1000C, a smart watch 1000D, a telephone 1000E, such as a smartphone, a personal computer 1000F, and an AR/VR device 1000G.

In a network environment in which the communications network 920 is the Internet, for example, the server computer 1000A can be a dedicated server computer operable to process and communicate data to and from the client computing devices 1000B-1000G via any of a number of known protocols, such as, hypertext transfer protocol (“HTTP”), file transfer protocol (“FTP”), a remote desktop protocol, TCP, UDP, or simple object access protocol (“SOAP”). Additionally, the networked computing environment 1000 can utilize various data security protocols such as secured socket layer (“SSL”) or pretty good privacy (“PGP”). Each of the client computing devices 1000B-1000G can be equipped with an operating system operable to support one or more computing applications or terminal sessions such as a web browser (not shown in FIG. 10), or other graphical user interface (not shown in FIG. 10), or a mobile desktop environment (not shown in FIG. 10) to gain access to the server computer 1000A.

The server computer 1000A can be communicatively coupled to other computing environments (not shown in FIG. 10) and receive data regarding a participating user's interactions/resource network. In an illustrative operation, a user (not shown in FIG. 10) may interact with a computing application running on a client computing device 1000B-1000G to obtain desired data and/or perform other computing applications.

The data and/or computing applications may be stored on the server 1000A, or servers 1000A, and communicated to cooperating users through the client computing devices 1000B-1000G over an exemplary communications network 920. A participating user (not shown in FIG. 10) may request access to specific data and applications housed in whole or in part on the server computer 1000A. These data may be communicated between the client computing devices 1000B-1000G and the server computer 1000A for processing and storage.

The server computer 1000A can host computing applications, processes and applets for the generation, authentication, encryption, and communication of data and applications, and may cooperate with other server computing environments (not shown in FIG. 10), third party service providers (not shown in FIG. 10), network attached storage (“NAS”) and storage area networks (“SAN”) to realize application/data transactions.

It should also be appreciated that the computing architecture shown in FIG. 9 and the distributed network computing environment shown in FIG. 10 have been simplified for ease of discussion. It should also be appreciated that the computing architecture and the distributed computing network can include and utilize many more computing components, devices, software programs, networking devices, and other components not specifically described herein.

The disclosure presented herein also encompasses the subject matter set forth in the following clauses:

Clause 1. A computer-implemented method for discovering one or more features provided by an operating system (OS) executing on a computing device, the method comprising: collecting user activity data on the computing device, the user activity data defining activity of a user with respect to the computing device; providing the user activity data to a trained machine learning model configured to select an OS-provided feature that is relevant to a current activity of the user; determining that the trained machine learning model selected an OS-provided feature that is relevant to the current activity of the user; and in response to determining that the trained machine learning model selected an OS-provided feature that is relevant to the current activity of the user, presenting a user interface comprising data identifying the OS-provided feature selected by the trained machine learning model.

Clause 2. The computer-implemented method of clause 1, further comprising: receiving a request from the user by way of the user interface to instantiate the OS-provided feature selected by the trained machine learning model; and instantiating the OS-provided feature selected by the trained machine learning model in response to the user request.

Clause 3. The computer-implemented method of any of clauses 1 or 2, further comprising: receiving a request from the user by way of the user interface to not instantiate the OS-provided feature selected by the trained machine learning model; and causing the trained machine learning model to be retrained in response to the user request to not instantiate the OS-provided feature.

Clause 4. The computer-implemented method of any of clauses 1-3, wherein the OS-provided feature selected by the trained machine learning model comprises an OS-provided feature for sharing files with nearby computing devices.

Clause 5. The computer-implemented method of any of clauses 1-4, wherein the OS-provided feature selected by the trained machine learning model comprises an OS-provided feature for providing a system-wide emoji picker.

Clause 6. The computer-implemented method of any of clauses 1-5, wherein the OS-provided feature selected by the trained machine learning model comprises an OS-provided clipboard history feature.

Clause 7. The computer-implemented method of any of clauses 1-6, wherein the trained machine learning model is trained using the user activity data and feature use data describing utilization of the OS-provided feature.

Clause 8. A computer-readable storage medium having computer-executable instructions stored thereupon which, when executed by a computing device, cause the computing device to: collect user activity data on the computing device, the user activity data defining a current activity of a user with respect to the computing device; provide the user activity data to a trained machine learning model configured to predict an operating system (OS)-provided feature that is relevant to the current activity of the user; determine that the trained machine learning model predicted an OS-provided feature that is relevant to the current activity of the user; and in response to determining that the trained machine learning model predicted an OS-provided feature that is relevant to the current activity of the user, presenting a user interface by way of the computing device, the user interface comprising data describing the OS-provided feature predicted by the trained machine learning model.

Clause 9. The computer-readable storage medium of clause 8, wherein the user interface comprises a first element and wherein the computer-readable storage medium has further computer-executable instructions stored thereupon which, when executed by the computing device, cause the computing device to: receive a selection of the first element; and responsive to receiving the selection of the first element, executing the OS-provided feature predicted by the trained machine learning model.

Clause 10. The computer-readable storage medium of clauses 8 or 9, wherein the user interface comprises a second element and wherein the computer-readable storage medium has further computer-executable instructions stored thereupon which, when executed by the computing device, cause the computing device to: receive a selection of the second element; and responsive to receiving the selection of the second element, initiating a retraining of the trained machine learning model.

Clause 11. The computer-readable storage medium of any of clauses 8-10, wherein the OS-provided feature selected by the trained machine learning model comprises an OS-provided feature for sharing files with nearby computing devices.

Clause 12. The computer-readable storage medium of any of clauses 8-11, wherein the OS-provided feature selected by the trained machine learning model comprises an OS-provided feature for providing a system-wide emoji picker.

Clause 13. The computer-readable storage medium of any of clauses 8-12, wherein the OS-provided feature selected by the trained machine learning model comprises an OS-provided clipboard history feature.

Clause 14. The computer-readable storage medium of any of clauses 8-13, wherein the trained machine learning model is trained using the user activity data and feature use data describing utilization of the OS-provided feature.

Clause 15. A computing device, comprising: at least one processor; and a computer-readable storage medium having computer-executable instructions stored thereupon which, when executed by the at least one processor, cause the computing device to: collect user activity data on the computing device, the user activity data defining a current activity of a user with respect to the computing device; provide the user activity data to a trained machine learning model configured to predict an operating system (OS)-provided feature that is relevant to the current activity of the user; determine that the trained machine learning model predicted an OS-provided feature that is relevant to the current activity of the user; and in response to determining that the trained machine learning model predicted an OS-provided feature that is relevant to the current activity of the user, presenting a user interface comprising data describing the OS-provided feature predicted by the trained machine learning model.

Clause 16. The computing device of clause 15, wherein the user interface comprises a first element and wherein the computer-readable storage medium has further computer-executable instructions stored thereupon which, when executed by the computing device, cause the computing device to: receive a selection of the first element; and responsive to receiving the selection of the first element, executing the OS-provided feature predicted by the trained machine learning model.

Clause 17. The computing device of clauses 15 or 16, wherein the user interface comprises a second element and wherein the computer-readable storage medium has further computer-executable instructions stored thereupon which, when executed by the computing device, cause the computing device to: receive a selection of the second element; and responsive to receiving the selection of the second element, initiating a retraining of the trained machine learning model.

Clause 18. The computing device of any of clauses 15-17, wherein the OS-provided feature selected by the trained machine learning model comprises an OS-provided feature for sharing files with nearby computing devices.

Clause 19. The computing device of any of clauses 15-18, wherein the OS-provided feature selected by the trained machine learning model comprises an OS-provided feature for providing a system-wide emoji picker.

Clause 20. The computing device of any of clauses 15-19, wherein the OS-provided feature selected by the trained machine learning model comprises an OS-provided feature for launching an application.

Based on the foregoing, it should be appreciated that technologies for machine learning assisted discovery and instantiation of OS-provided features have been disclosed herein. Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method for discovering one or more features provided by an operating system (OS) executing on a computing device, the method comprising:
collecting user activity data on the computing device, the user activity data defining activity of a user with respect to the computing device;
providing the user activity data to a trained machine learning model configured to select an OS-provided feature that is relevant to a current activity of the user;
determining that the trained machine learning model selected an OS-provided feature that is relevant to the current activity of the user; and
in response to determining that the trained machine learning model selected an OS-provided feature that is relevant to the current activity of the user, presenting a user interface comprising data identifying the OS-provided feature selected by the trained machine learning model.

2. The computer-implemented method of claim 1, further comprising:
receiving a request from the user by way of the user interface to instantiate the OS-provided feature selected by the trained machine learning model; and
instantiating the OS-provided feature selected by the trained machine learning model in response to the user request.

3. The computer-implemented method of claim 1, further comprising:
receiving a request from the user by way of the user interface to not instantiate the OS-provided feature selected by the trained machine learning model; and
causing the trained machine learning model to be retrained in response to the user request to not instantiate the OS-provided feature.

4. The computer-implemented method of claim 1, wherein the OS-provided feature selected by the trained machine learning model comprises an OS-provided feature for sharing files with nearby computing devices.

5. The computer-implemented method of claim 1, wherein the OS-provided feature selected by the trained machine learning model comprises an OS-provided feature for providing a system-wide emoji picker.

6. The computer-implemented method of claim 1, wherein the OS-provided feature selected by the trained machine learning model comprises an OS-provided clipboard history feature.

7. The computer-implemented method of claim 1, wherein the trained machine learning model is trained using the user activity data and feature use data describing utilization of the OS-provided feature.

8. A computer-readable storage medium having computer-executable instructions stored thereupon which, when executed by a computing device, cause the computing device to:
collect user activity data on the computing device, the user activity data defining a current activity of a user with respect to the computing device;
provide the user activity data to a trained machine learning model configured to predict an operating system (OS)-provided feature that is relevant to the current activity of the user;
determine that the trained machine learning model predicted an OS-provided feature that is relevant to the current activity of the user; and
in response to determining that the trained machine learning model predicted an OS-provided feature that is relevant to the current activity of the user, presenting a user interface by way of the computing device, the user interface comprising data describing the OS-provided feature predicted by the trained machine learning model.

9. The computer-readable storage medium of claim 8, wherein the user interface comprises a first element and wherein the computer-readable storage medium has further computer-executable instructions stored thereupon which, when executed by the computing device, cause the computing device to:
receive a selection of the first element; and
responsive to receiving the selection of the first element, executing the OS-provided feature predicted by the trained machine learning model.

10. The computer-readable storage medium of claim 9, wherein the user interface comprises a second element and wherein the computer-readable storage medium has further computer-executable instructions stored thereupon which, when executed by the computing device, cause the computing device to:
receive a selection of the second element; and
responsive to receiving the selection of the second element, initiating a retraining of the trained machine learning model.

11. The computer-readable storage medium of claim 8, wherein the OS-provided feature selected by the trained machine learning model comprises an OS-provided feature for sharing files with nearby computing devices.

12. The computer-readable storage medium of claim 8, wherein the OS-provided feature selected by the trained machine learning model comprises an OS-provided feature for providing a system-wide emoji picker.

13. The computer-readable storage medium of claim 8, wherein the OS-provided feature selected by the trained machine learning model comprises an OS-provided clipboard history feature.

14. The computer-readable storage medium of claim 8, wherein the trained machine learning model is trained using the user activity data and feature use data describing utilization of the OS-provided feature.

15. A computing device, comprising:
at least one processor; and
a computer-readable storage medium having computer-executable instructions stored thereupon which, when executed by the at least one processor, cause the computing device to:
collect user activity data on the computing device, the user activity data defining a current activity of a user with respect to the computing device;
provide the user activity data to a trained machine learning model configured to predict an operating system (OS)-provided feature that is relevant to the current activity of the user;
determine that the trained machine learning model predicted an OS-provided feature that is relevant to the current activity of the user; and
in response to determining that the trained machine learning model predicted an OS-provided feature that is relevant to the current activity of the user, presenting a user interface comprising data describing the OS-provided feature predicted by the trained machine learning model.

16. The computing device of claim 15, wherein the user interface comprises a first element and wherein the computer-readable storage medium has further computer-executable instructions stored thereupon which, when executed by the computing device, cause the computing device to:
receive a selection of the first element; and
responsive to receiving the selection of the first element, executing the OS-provided feature predicted by the trained machine learning model.

17. The computing device of claim 15, wherein the user interface comprises a second element and wherein the computer-readable storage medium has further computer-executable instructions stored thereupon which, when executed by the computing device, cause the computing device to:
receive a selection of the second element; and
responsive to receiving the selection of the second element, initiating a retraining of the trained machine learning model.

18. The computing device of claim 15, wherein the OS-provided feature selected by the trained machine learning model comprises an OS-provided feature for sharing files with nearby computing devices.

19. The computing device of claim 15, wherein the OS-provided feature selected by the trained machine learning model comprises an OS-provided feature for providing a system-wide emoji picker.

20. The computing device of claim 15, wherein the OS-provided feature selected by the trained machine learning model comprises an OS-provided feature for launching an application.
